(19) United States
(12) Patent Application Publication
(10) Pub. No.: US 2024/0362916 A1
(43) Pub. Date: Oct. 31, 2024

(54) AUTOMATED TRACKING AND DETECTION OF HYGIENE STATE IN A HYGIENE SENSITIVE ENVIRONMENT

(71) Applicant: Lagen Holding LTD, Gibraltar (GI)

(72) Inventor: Kjell Knoop, Lvov (UA)

(21) Appl. No.: 18/638,570

(22) Filed: Apr. 17, 2024

Related U.S. Application Data
(60) Provisional application No. 63/497,019, filed on Apr. 19, 2023.

(51) Int. Cl. G06V 20/52; G06V 10/22; G06V 10/26; G06V 20/40; G06V 40/10; G06V 40/20

(52) U.S. Cl. CPC G06V 20/52; G06V 10/225; G06V 10/26; G06V 20/44; G06V 40/10; G06V 40/20

(57) ABSTRACT

Techniques include detecting a person in an area having a target region and annotating a source region surrounding the person according to a hygiene state. When a collision between the source region and the target region is detected, an indicator indicates a violation or a non-violation according to the hygiene state. In some implementations, the hygiene state is one of clean, contaminated, and in process. When the person enters the room, the source region is in a contaminated state until they have performed a hygienic act (e.g., hand washing); after performing the hygienic act, the source region is in a clean state. If a source region in a clean state intersects a target region (e.g., area around a patient's bed), then the indicator indicates a non-violation. If a source region in a contaminated state intersects a target region, then the indicator indicates a violation.

### CROSS REFERENCE TO RELATED APPLICATION

This application claims the benefit of U.S. Provisional Application No. 63/497,019, filed Apr. 19, 2023, the disclosure of which is incorporated herein by reference in its entirety.

### BACKGROUND

In hygiene-sensitive environments such as hospital rooms, the World Health Organization has identified five moments at which hand hygiene should be performed: 1) before touching a patient; 2) before a clean/aseptic procedure; 3) after body fluid exposure; 4) after touching a patient; and 5) after touching patient surroundings. Conventional approaches to minimizing risk of exposure to illness/infection involves institutions such as hospitals relying on their staff to know these moments and implement procedures that will ensure patient and their own safety.

### SUMMARY

In one general aspect, a method for automated tracking and detection of hygiene state in a hygiene sensitive area can include receiving a sequence of images of the area, the area including a target region. The method can also include detecting, based on at least one image of the sequence of images of the area, one or more persons in the area, and defining a source region that surrounds the one or more persons. The method can further include assigning a hygiene state to the source region based on the sequence of images of the area. The method can further include detecting, based on at least one image of the sequence of images of the area, whether there has been a collision event between the target region and the source region. The method can further include, in response to detecting that there has been a collision event between the target region and the source region, triggering a presentation of an indicator indicative of the hygiene state of the source region.

In another general aspect, a computer program product comprises a non-transitory storage medium, the computer program product including code that, when executed by processing circuitry, causes the processing circuitry to perform a method for automated tracking and detection of hygiene state in a hygiene sensitive area. The method can include receiving a sequence of images of the area, the area including a target region. The method can also include detecting, based on at least one image of the sequence of images of the area, one or more persons in the area, and defining a source region that surrounds the one or more persons. The method can further include assigning a hygiene state to the source region based on the sequence of images of the area. The method can further include detecting, based on at least one image of the sequence of images of the area, whether there has been a collision event between the target region and the source region. The method can further include, in response to detecting that there has been a collision event between the target region and the source region, triggering a presentation of an indicator indicative of the hygiene state of the source region.

In another general aspect, an apparatus for automated tracking and detection of hygiene state in a hygiene sensitive area comprises memory, and processing circuitry coupled to the memory. The processing circuitry can be configured to receive a sequence of images of the area, the area including a target region. The processing circuitry can also be configured to detect, based on at least one image of the sequence of images of the area, one or more persons in the area, and defining a source region that surrounds the one or more persons. The processing circuitry can further be configured to assign a hygiene state to the source region based on the sequence of images of the area. The processing circuitry can further be configured to detect, based on at least one image of the sequence of images of the area, whether there has been a collision event between the target region and the source region. The processing circuitry can further be configured to, in response to detecting that there has been a collision event between the target region and the source region, trigger a presentation of an indicator indicative of the hygiene state of the source region.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram illustrating an example area including a target region and

source regions.

FIG. 2a is a flow chart illustrating an example process of determining whether a hygiene violation occurred.

FIG. 2b is a flow chart illustrating an example process of a training algorithm for detection of collisions between identified objects.

FIG. 2c is a flow chart illustrating an example of determining whether a hygiene violation has occurred in a hygiene sensitive area.

FIG. 3 is a diagram illustrating an example area including keypoints for people within source regions.

FIG. 4 is a diagram illustrating an example area including a target region that has had a segmentation operation performed on it.

FIG. 5 is a diagram illustrating an example electronic environment for performing the improved techniques described herein.

FIG. 6 is a flow chart illustrating an example method of tracking hygiene state.

FIG. 7 illustrates a system overview for several hygiene sensitive areas configured for hygiene protocols.

FIG. 8 illustrates a system overview for several hygiene sensitive areas configured for hygiene protocols.

### DETAILED DESCRIPTION

This disclosure relates to systems and methods for determining whether a person in a hygiene-sensitive environment such as a hospital room is following a hygiene protocol. For example, the World Health Organization has identified five moments at which hand hygiene should be performed: 1) before touching a patient; 2) before a clean/aseptic procedure; 3) after body fluid exposure; 4) after touching a patient; and 5) after touching patient surroundings. Conventional approaches to minimizing risk of exposure to illness/infection involves institutions such as hospitals relying on their staff to know these moments and implement procedures that will ensure safety for the patient(s) and themselves.

A technical problem with the above conventional approaches to minimizing risk of exposure to illness/infection is that there may be no way to track whether a staff member has obeyed hygiene protocols in advance of the moments at which hand hygiene should have been performed. For example, even if a person has washed their hands, there is no way to know whether that person has come into contact with another person before tending to a patient, and if so whether the other person has washed their hands. This lack of hygiene tracking could compromise patient and staff safety.

Disclosed implementations provide a technical solution to at least the above technical problem, which solution can involve detecting a person in an area having a target region and annotating a source region associated with and surrounding the person according to a hygiene state. When a collision between the source region and the target region is detected, an indicator is presented (e.g., inside the room) that indicates a violation or a non-violation according to the hygiene state. In some implementations, the hygiene state is one of clean, contaminated, and in process. When the person enters the room, the source region is in a contaminated state until a hygienic act has been performed by the source region (e.g., hand washing); after performing the hygienic act, the source region is in a clean state. If a source region in a clean state intersects a target region (e.g., area around a patient's bed), then the indicator indicates a non-violation. If a source region in a contaminated state intersects a target region, then the indicator indicates a violation.

A technical advantage of the technical solution just described is that the technical solution allows one to track whether people dealing with patients have taken proper hygienic care; this reduces risk of illness/infection.

In some implementations, assigning the hygiene state to the source region includes selecting one hygiene state of a clean state, a contaminated state, or an in process state, and assigning the selected hygiene state to the source region. In such implementations, in response to the hygiene state assigned to the source region being the contaminated state, the indicator indicates a hygiene violation and in response to the hygiene state assigned to the source region being the clean state, the indicator indicates a hygiene non-violation.

In some implementations, determining the hygiene state of the source region includes assigning the contaminated state to a source region upon detecting a person entering an area or a person leaving the area.

In some implementations, the area also includes a hygiene station region. In such implementations, assigning the hygiene state to the source region includes detecting that there has been a collision event between the source region and the hygiene station region over at least a subset of the sequence of images, the subset of the sequence of images representing a minimum time for which the person is performing a hygiene act at the hygiene station region; and in response to the detecting that there has been a collision event between the source region and the hygiene station region over at least the subset of the sequence of images, assigning the clean state to the source region.

In some implementations, assigning the hygiene state to the source region includes receiving a signal indicating that the person has performed a hygiene act at a hygiene station; and in response to receiving the signal, assigning the clean state to the source region.

In some implementations, assigning the hygiene state to the source region includes detecting a second person in the room, the second person being surrounded by a second source region, the second source region having been assigned a hygiene state; detecting a collision event between the source region and the second source region; and assigning the hygiene state of the source region based on the hygiene state assigned to the second source region.

In some implementations, the target region surrounds a patient bed region and includes an axis-aligned bounding box (AABB) around the patient bed area.

In some implementations, detecting whether there has been a collision event between the target region and the source region includes determining whether the source region intersects the AABB.

In some implementations, the target region surrounds a patient bed area. In such implementations, detecting whether there has been a collision event between the target region and the source region includes performing a segmentation operation on the patient bed area to produce, as the target region, a polygonal region.

In some implementations, detecting whether there has been a collision event between the target region and the source region further includes determining a set of keypoints on the person; and detecting whether at least one of the set of keypoints on the person has intersected the polygonal region.

In some implementations, the set of keypoints are located at a head, hands, elbows, and feet of the person.

In some implementations, detecting the person in the area includes detecting a body of the person, the body being represented by a first rectangular region; and detecting a head of the person, the head being represented by a second rectangular region. In such implementations, the source region includes an intersection between the first rectangular region and the second rectangular region.

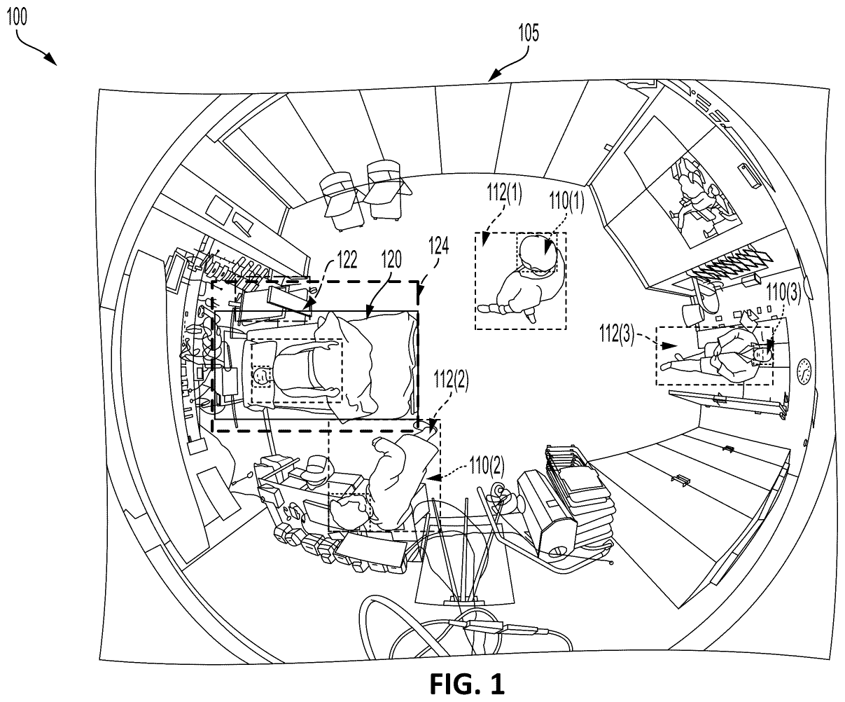

FIG. 1 is a diagram illustrating an example image 100 of an area 105 including a target region 124 and source regions 112(1), 112(2), and 112(3).

The image 100 is one of a sequence of images taken using a camera with a fisheye lens disposed above the area 105; accordingly, the image 100 is a 360-degree view of the area 105 from above. For example, as shown in FIG. 1, the area 105 represents a hospital room, although other hygiene-sensitive environments are possible.

The camera is connected to processing circuitry that analyzes the image 100 and detects a bed 120 on which a patient lies and a table 122 next to the bed 120. A region around the bed 120 and table 122 may be defined as a target region 124 (or, in this specific case, a patient zone). The objective is to keep the target region 124 as hygienic as possible by triggering an indicator (e.g., an alert, an alarm) in response to detecting that any of people 110(1), 110(2), 110(3) (e.g., workers, visitors) has not taken sufficient hygiene measures (e.g., washing hands for a minimum time) and enters the target region.

The processing circuitry detects the bed 120 and table 122 in the image 100 using an algorithm that is here referred to as a bed and table detection algorithm. The bed and table detection algorithm includes, in some implementations, a machine learning algorithm trained to classify objects in an area (e.g., area 105) as being a bed or not being a bed, and as being a table or not being a table. In some implementations, the machine learning algorithm is a convolutional neural network.

Once the bed 120 and table 122 are detected, the processing circuitry defines the target region 124 using a bounding box. In some implementations, the processing circuitry uses an axis-aligned bounding box (AABB) to define the target region 124. An advantage of using an AABB is fast processing speeds in detecting a collision with the target region 124. Other possible definitions of the target region are defined below.

The processing circuitry detects one or more persons, here people 110(1), 110(2), and 110(3), in the area 105 using the image 100. By detecting people for each image in the sequence, the processing circuitry tracks the person(s), here the people 110(1), 110(2), 110(3), as they move about the area 105. In some implementations, the processing circuitry detects a person (e.g., person 110(1)) by detecting for that person a body and a head. In such implementations, a person is then defined as a union between the body and the head. An advantage of detecting a person in this manner is that it is easier to track a single person out of many people over a sequence of images.

The processing circuitry defines source regions 112(1), 112(2), 112(3) for each person 110(1), 110(2), 110(3), respectively. In some implementations, a source region (e.g., source region 112(1)) is defined as a bounding box over a union of a head and body. In some implementations, the bounding box is an AABB.

At any moment in time, a person (e.g., person 110(1)) may or may not be hygienic enough, according to a hygiene protocol, to enter the target region 124. Therefore, the source region (e.g., source region 112(1)) associated with the person is assigned a hygiene state by the processing circuitry based on the sequence of images. The hygiene state assigned can be one of clean, contaminated, or in process. A clean state corresponds to when the person is considered as satisfying the hygiene protocols as posted by an institution and as such is allowed to enter the target region 124. A contaminated state corresponds to when the person is considered as not satisfying the hygiene protocols as posted by the institution and as such is not allowed to enter the target region 124. An in process state corresponds to when the person is in the process of performing a hygiene act (e.g., washing hands) as specified in the hygiene protocols.

For example, as shown in FIG. 1, the person 110(3) has just entered the area 105. As such the processing circuitry assigns the contaminated state to the source region 112(3) of the person 110(3). Accordingly, until the person 110(3) goes to the hygiene station and performs the hygiene act (e.g., washes hands for a minimum time), the source region 112(3) will remain assigned to the contaminated state. If, while assigned to the contaminated state, the source region 112(3) collides with (intersects with) the target region 124, the processing circuitry will trigger presentation of an indicator indicating that there has been a violation of the hygiene protocols. In some implementations, the processing circuitry will also flag the target region as contaminated.

In some implementations, the indicator is a visual indicator. In some implementations, the visual indicator is a solid light (e.g., a red light). The solid red light is in opposition to a solid green light that indicates no violation of the hygiene protocols. In some implementations, the indicator is an audio indicator. In some implementations, the indicator is a tactile indicator.

An example of the hygiene protocols are the World Health Organization's (WHO's) five moments, namely: hand hygiene should be performed: 1) before touching a patient; 2) before a clean/aseptic procedure; 3) after body fluid exposure; 4) after touching a patient; and 5) after touching patient surroundings.

Accordingly, according to the WHO's five moments, the source region 112(3) is assigned to the contaminated state upon entry to the area 105. The source region 112(3) remains assigned to the contaminated state until the person 110(3) performs the hygiene act (e.g., hand washing for a minimum time). Immediately after the person 110(3) performs the hygiene act, the processing circuitry assigns the source region 112(3) to the clean state. The person 110(3) whose source region is presently associated with the clean state may enter the target region 124 (have a collision detected between source region 112(3) and target region 124) without incurring a violation of the hygiene protocols.

Nevertheless, once the source region 112(3) is no longer intersected with the target region 124 after having intersected it, the processing circuitry instead assigns the contaminated state to the source region 112(3). For example, the person 110(3) might have come into contact with the patient or the patient's bodily fluids. Accordingly, the person 110(3) would have to perform another hygiene act before the source region 112(3) can come into contact with the target region 124 (e.g., collide with the target region 124).

Moreover, the processing circuitry assigns the contaminated state to the source region 112(3) when the person 110(3) exits the area 105. This assignment is made even when the person has performed the hygiene act immediately before leaving the area 105 and has not subsequently been in contact with the patient or the patient's surroundings. Accordingly, the processing circuitry assigns the contaminated state to each person's source region upon the person entering the area 105 and exiting the area 105.

There may also be a collision between source regions corresponding to two or more people in the area 105. When source regions (e.g., source regions 110(2) and 110(3)) collide, the resulting hygiene state of the source regions depends on the previous hygiene states of the source regions. For example, if the contaminated state is assigned to the source region 112(2) and the clean state is assigned to the source region 112(3), upon a collision both source regions are assigned to the contaminated state. If both source regions presently have the same hygiene state (e.g., both clean or both contaminated), then the hygiene states are unchanged after a collision of the source regions.

It is noted that, while a source region or a target region may be detected from a single image (e.g., image 100), the hygiene state assigned to a source region may be detected over multiple images in a sequence. For example, the clean state may only be assigned to a source region based on an action (e.g., hand washing) taking place over previous frames.

A collision between a source region (e.g., source region 112(3)) and the target region 124, or between two source regions, however, may be detected from a single image (e.g., image 100). For example, the processing circuitry may detect a collision between two AABBs geometrically based on, e.g., the coordinates of the AABBs.

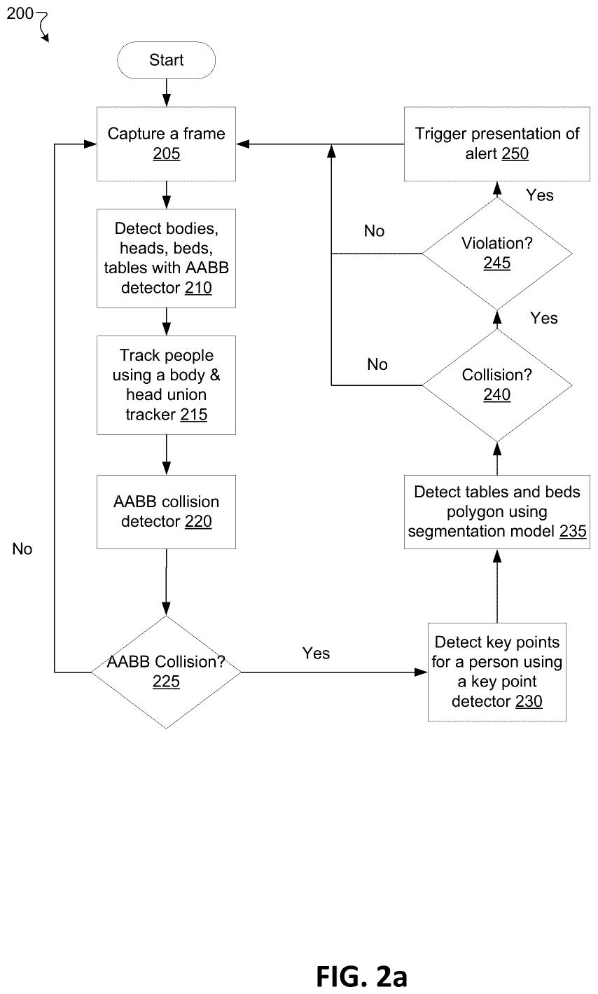

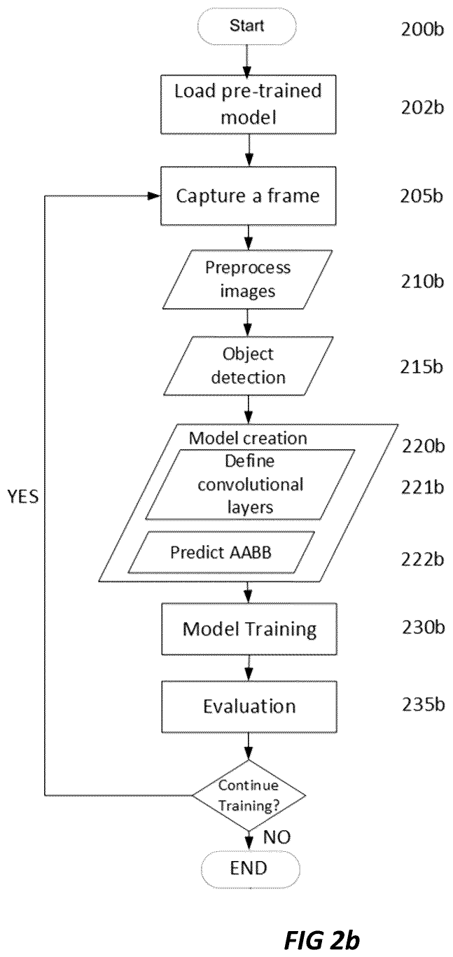

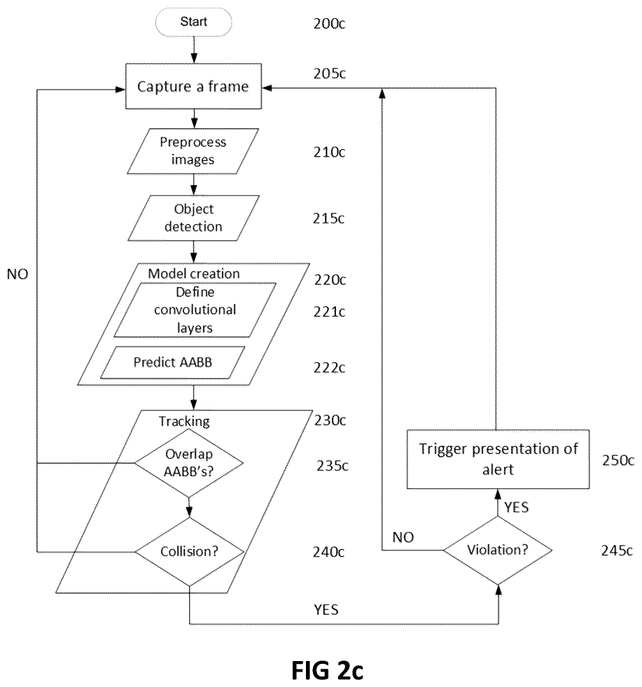

Collision detection between a source region and the target region 124, however, may not accurately indicate that there has been contact between person and patient. For example, as shown in FIG. 1, the table is a small rectangle besides the larger bed. The AABB defining the target region 124, then, includes some of the space in the area 105 that is not associated with the patient. Accordingly, the AABB collision detection, in some implementations, may be only a first step in determining whether there has been contact between the person and the patient. A process in which there are additional steps for a more accurate collision detection is presented with regard to FIGS. 2-4.

FIG. 2a is flow chart illustrating an example process 200 of determining whether a hygiene violation occurred. The process 200 is carried out using processing circuitry such as vision processing units, designed for accelerating AI workloads, and in particular Convolutional Neural Networks, e.g., a Jetson AGX Xavier made by Nvidia Corp.

At operation 205, the processing circuitry captures an image of a sequence of images. For example, as shown in FIG. 1, a camera may be on a ceiling or generally above an area (e.g., area 105). When the camera has a fisheye lens, the images in the sequence are 360-degree views of the area.

At operation 210, the processing circuitry detects one or more bodies, heads, beds, and tables and/or other objects in the area based on the captured image. The processing circuitry detects the bodies, heads, beds, and tables etc. by using a machine learning detection algorithm; by using the algorithm over several images of the sequence, the processing circuitry tracks the movement of the bodies and heads through the area. In some implementations, the machine learning detection algorithm includes a convolutional neural network.

At operation 215, the processing circuitry determines one or more individual people by using a head and body union tracker. The head and body union tracker forms a union of a body and head by tracking the movement of a head and a corresponding body over multiple images of the sequence. The union of the head and body is formed, in some implementations, using a machine learning algorithm such as a convolutional neural network.

At operation 220, the processing circuitry determines an AABB for each of the individual people to define source regions and the bed/table combination to define the target region. Once the AABBs have been determined, the processing circuitry determines whether there has been a collision between a source region and the target region or between two source regions. The collision detection here is performed using geometry, e.g., analysis of the coordinates of the AABBs.

At operation 225, if a collision is not detected, the process 200 goes back to operation 205. If a collision has been detected, however, the process 200 advances to operation 230 for a more advanced collision detection, the more advanced collision detection may include use of deep learning neural networks or utilizing keypoints detection.

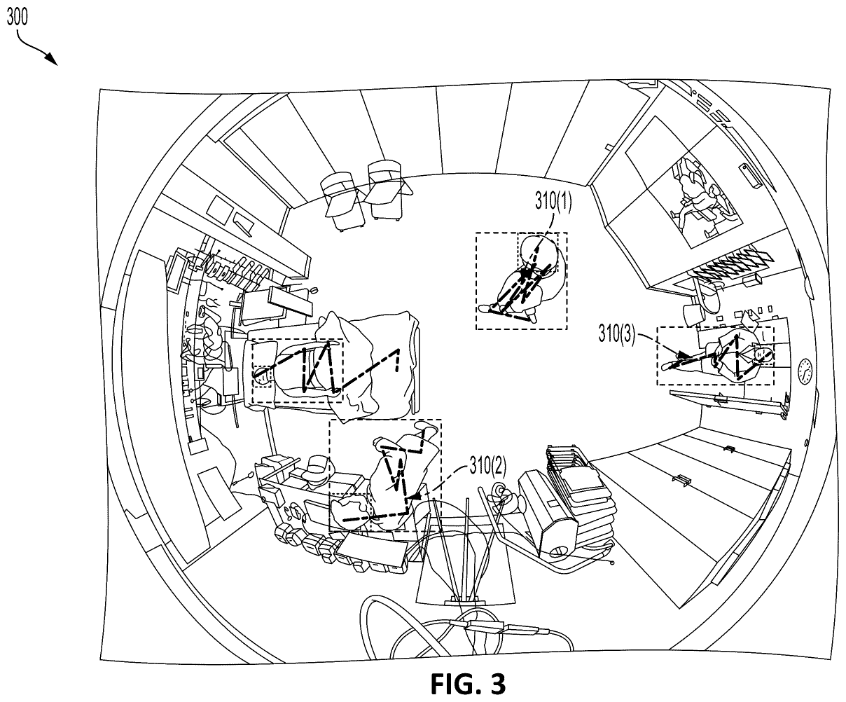

At operation 230, the processing circuitry performs a keypoint detection of the people in the area. In some implementations, the keypoints are located at the head, the hands, the elbows, and the feet; in some implementations, there may be more or fewer keypoints. Such keypoints are shown in FIG. 3.

The flow chart of FIG. 2a includes two levels of granularity: the first level uses AABB, while the second level which is more fine grained uses keypoints for humans and segmentation for objects. In other embodiments AABB is combined with deep learning using convolutional neural networks.

FIG. 2b illustrates an example training process for a deep learning algorithm. Training a deep learning model involves feeding the deep learning model data and allowing the deep learning model to adjust its weights and biases to minimize errors. Backpropagation and gradient descent can be used to adjust the model's weights and biases. The training example does not mean that deep learning training is not performed during normal operations; on the contrary, the model can become more and more accurate, and thus the hygiene protocol also improves. The purpose of the initial deep learning training is to ensure that the models to be used in normal operations are initially good enough.

Now turning to FIG. 2b, the process 200b may be carried out using processing circuitry such as vision processing units, designed for accelerating AI workloads, and in particular Convolutional Neural Networks e.g., a Jetson AGX Xavier made by Nvidia Corp. At step 202b pre trained models are loaded into the memories of the processing circuit.

At operation 205b, the processing circuitry captures an image of a sequence of images. Creating Axis-Aligned Bounding Boxes (AABB) from the captured images may involve the following steps:
210b Image Preprocessing: Preprocessing the images may be useful to make images less complex to make it easier for the bounding box algorithm to work. Preprocessing may include converting the image to grayscale, blurring, thresholding, etc. The step 210b may include, in some implementations, converting image to grayscale, thresholding the image, and finding contours in the thresholded image.
215b Object Detection: An object detection algorithm may be used to identify objects in the image to create bounding boxes such as AABB. The object detection algorithm may, in some implementations, use a pre-trained model like YOLO (You Only Look Once), SSD (Single Shot MultiBox Detector), or Faster R-CNN (Region Convolutional Neural Networks).
220b Model creation: Model creation includes to create bounding boxes. For each contour in step 210b, one may find the minimal and maximal x and y coordinates that contain the object. These coordinates define the AABB.
221b Define convolutional layers: The convolutional layers are designed to automatically and adaptively learn spatial hierarchies of features from the input data. Each convolutional layer includes a number of filters and the size of the filter is dependent on the complexity of the available image data. Images of humans are more complex than images of fixed objects, and hence the filters for fixed objects are fewer and the size of the filters are smaller than for humans. After each convolutional layer, a pooling layer can be added to reduce the spatial size of the representation, to control overfitting, and to progressively increase the receptive field of the filters.
222b Predict AABB: In the context of AABB prediction, an output layer would typically have as many units as there are parameters to predict for each bounding box (e.g., the x and y coordinates of the center of the box, and the box's width and height). These models will need to be trained on labeled data, where each object (human, fixed objects, etc.) is annotated with an Axis-Aligned Bounding Box (AABB) and a class label. The trained model can then predict the AABB and the class label for each object in new, unseen images.
230b Model Training: The model may be trained on a preprocessed dataset. The model may take the images as input and aim to minimize a loss function that takes into account classification error (e.g., whether the predicted object matches the actual object) and bounding box error (e.g., how far off the predicted bounding box is from the actual bounding box).
235b Evaluation: The model's performance may be evaluated on a separate test set.
Continue training: When the model training is sufficiently good to start practicing the hygiene-protocol, the training algorithm can be terminated.

FIG. 2c, in contrast to FIG. 2a, shows a flowchart for a hygiene protocol where AABB is used in conjunction with deep learning instead of using keypoints and segmentation. The flow chart illustrates an example process 200c of determining whether a hygiene violation has occurred. The process 200c may be performed using processing circuitry such as vision processing units, designed for accelerating AI workloads, and in particular Convolutional Neural Networks e.g., a Jetson AGX Xavier made by Nvidia Corp.

At operation 205c, the processing circuitry captures an image of a sequence of images. The operations 210c, 215c, 220c, 221c and 222c are similar to those described with reference to FIG. 2b. The tracking steps follow after step 222c; it is in the tracking steps that collisions are detected.

There are several methods that can be used for tracking humans, i.e. AABBs. In operation 235c an overlap AABB test is performed. In an example the performance of the overlap AABB test means comparing the overlap of bounding boxes between consecutive frames. One may also use dedicated tracking algorithms like the Kalman filter or the Hungarian algorithm. If there is not an overlap of AABB's the process moves to operation 205c and the process repeats itself. If there is an overlap between AABB's this indicates a collision and a collision of AABBs may be a violation of the hygiene protocol. If the processing circuitry determines that there has been an advanced collision, then the process 200c advances to operation 245c.

When tracking Axis-Aligned Bounding Boxes (AABBs), to see if a collision has occurred one can use a point versus AABB method, i.e. see if a coordinate is inside an AABB, this method might be applied to fixed objects, another method implies the use of AABB's axis using boxes' boundaries. Two examples are given below:

1. Point Vs. AABB Collision:
To check if a point is inside an AABB, compare the point's coordinates with the AABB's boundaries along each axis.
For a point with coordinates (Px, Py, Pz) and an AABB with ranges (Aminx, AmaxX), (AminY, AmaxY), and (Aminz, Amaxz), the following formula can be applied:

$$f ( P , A ) = ( Px \geq A min X ⋀ Px \leq A max X ) ⋀ ( Py \geq A min Y ⋀ Py \leq A max Y ) ⋀ ( Pz \geq A min Z ⋀ Pz \leq A max Z )$$

The formula can be implemented in Java script, one example is shown below:

```
function isPointInsideAABB(point, box) {
    return (
      point.x >= box.minX && point.x <= box.maxX &&
      point.y >= box.minY && point.y <= box.maxY &&
      point.z >= box.minZ && point.z <= box.maxZ
  );
}
```

2. Aabb Vs. Aabb Collision:
To determine if two AABBs intersect, perform a test for each axis using the boxes' boundaries.
For AABBS A and B, check if the ranges overlap the following formula can be applied:

$$f ( A , B ) = ( A min X \leq B max X ⋀ A max X \geq B min X ) ⋀ ( A min Y \leq B max Y ⋀ A max Y \geq B min Y ) ⋀ ( A min Z \leq B max Z ⋀ A max Z \geq B min Z )$$

This formula can be implemented in Java script, one example is given below:

```
function intersect(a, b) {
  return (
    a.minX <= b.maxX && a.maxX >= b.minX &&
    a.minY <= b.maxY && a.maxY >= b.minY &&
    a.minZ <= b.maxZ && a.maxZ >= b.minZ
  );
}
```

In the above examples of tracking objects and detecting collisions between tracked objects using bounding boxes are described, however optionally, bounding spheres can be used. Using bounding spheres for collision detection is more complex but still fairly quick to test.

AABBs are axis-aligned, which means they do not necessarily fit the actual 3D object perfectly but provide computational efficiency for collision checks. If the objects will be rotating, an option is to use other bounding geometries like spheres, which are invariant to rotation.

At operation 245c, the processing circuitry determines whether there has been a hygiene violation given that an AABB overlap was detected. For example, based on previous images in the sequence, the processing circuitry assigns the contaminated state to the source region associated with the keypoints involved in the advanced collision. A scheme for determining a violation of the hygiene protocol may depend on the circumstances. An example of a scheme can be:

| Region | State | State | State | State |
|---|---|---|---|---|
| Source 1 | Contaminated | Clean | Contaminated | Clean |
| Source 2 | Contaminated | Contaminated | Clean | Clean |
| Violation? | Yes | Yes | Yes | No |

Violation of the hygiene protocol will move the process 200c to operation 250c where an alarm may be triggered. If no violation has occurred the process 200c starts on all over again from operation 205c.

FIG. 3 is a diagram illustrating an image 300 showing an example area including sets of keypoints 310(1), 310(2), 310(3) for people within source regions. (It is noted that there are also keypoints shown for the patient in the bed.) Within each source region there is a zigzag trace pattern representing the keypoint detection. As shown in FIG. 3, the keypoints are the endpoints of the respective trace inside each source region. In some implementations, the processing circuitry determines the keypoints corresponding to a person (e.g., a union of a head and a body) based on a machine learning algorithm. In some implementations, the machine learning algorithm is a convolutional neural network.

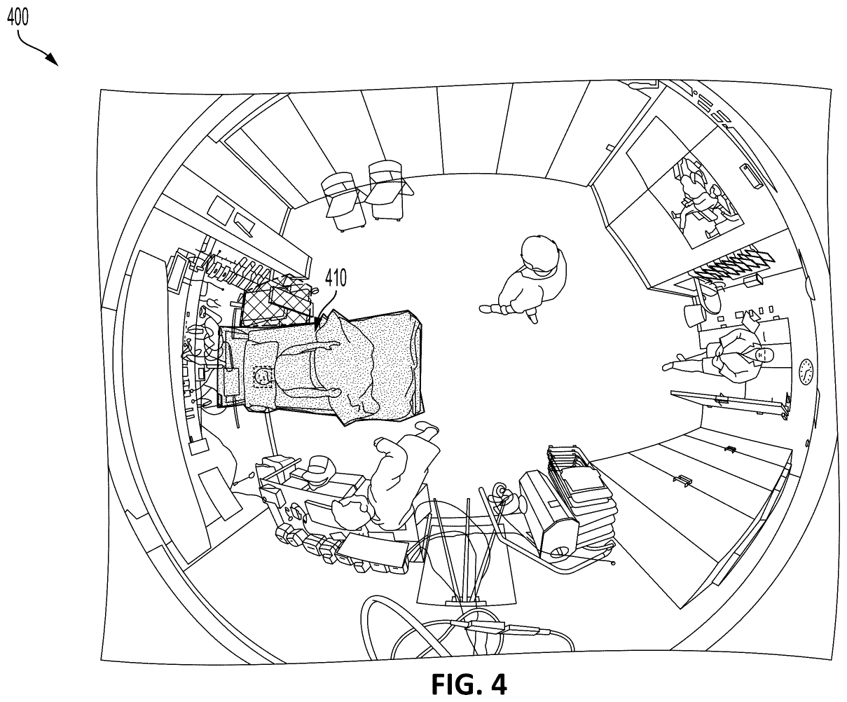

Returning briefly to FIG. 2a, at operation 235, the processing circuitry performs a segmentation of the bed and table to produce a polygon representing the target region. The polygon representation is shown in FIG. 4.

FIG. 4 is a diagram illustrating an example image 400 showing an area including a bed and table on which a segmentation operation has been performed. Rather than representing the target region as an AABB with a lot of additional space inside that is not in the patient zone, the segmentation operation here defines the target region in terms of a polygon 410 that conforms closely to the bed and table. In some implementations, the processing circuitry performs the segmentation operation using a machine learning algorithm.

Returning to FIG. 2a, at operation 240 the processing circuitry determines whether there has been a collision between the keypoints associated with a person and the segmentation polygon representing the target region. In some implementations, the determination of whether there has been such an advanced collision is made using a machine learning algorithm. In some implementations, the determination of whether there has been such an advanced collision is made using a geometric representation of the keypoints and the segmentation polygon, e.g., using the keypoints and polygon coordinates. If the processing circuitry determines that there has been no advanced collision, then the process 200 goes back to operation 205. If the processing circuitry determines that there has been an advanced collision, then the process 200 advances to operation 245.

At operation 245, the processing circuitry determines whether there has been a hygiene violation given that an advanced collision was detected. For example, based on previous images in the sequence, the processing circuitry assigns the contaminated state to the source region associated with the keypoints involved in the advanced collision. For example, the person entered the area without performing a hygiene act (e.g., washing hands). In this case, the processing circuitry flags a violation of hygiene protocols. In some implementations, this flag takes the form of a red light on the patent bed. The process 200 then proceeds to operation 205.

In another example, based on previous images in the sequence, the processing circuitry assigns the clean state to the source region associated with the keypoints involved in the advanced collision. For example, the person approached the target region (bed and table polygon) immediately after performing the hygiene act. In this case, the processing circuitry flags no violation of the hygiene protocols. In some implementations, this flag takes the form of a green light on the patent bed. The process 200 then proceeds to operation 205.

The process 200 as shown in FIG. 2a is one example of a process for recognizing whether a hygiene violation has occurred. Other example processes are possible. For example, a violation may be flagged directly after detecting an AABB collision. In another example, the keypoints and segmentation are performed first without an AABB being derived.

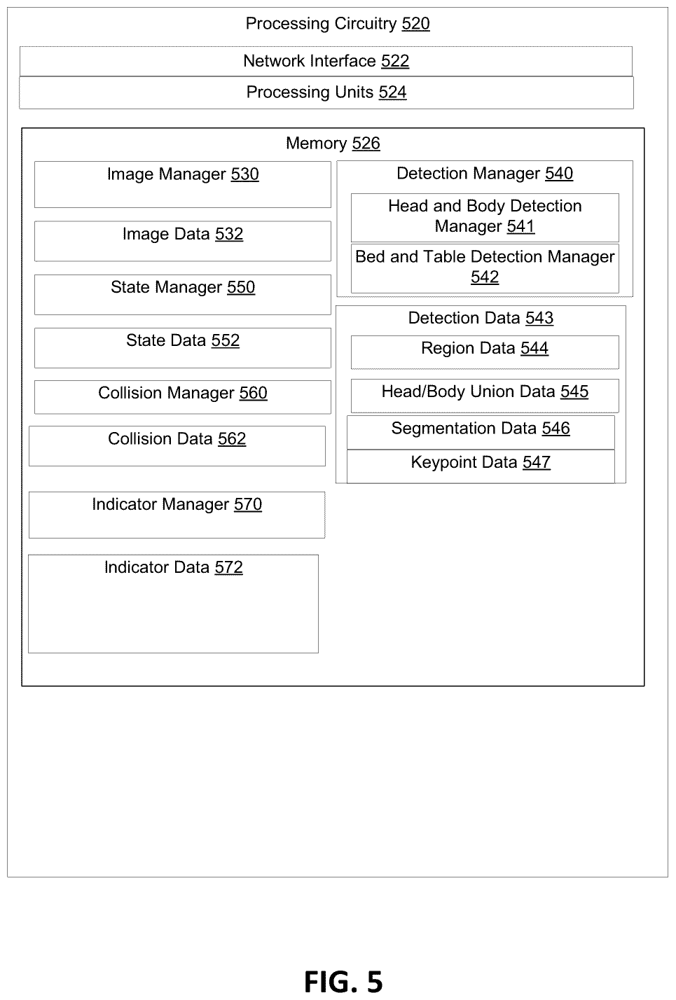

FIG. 5 is a diagram that illustrates an example of processing circuitry 520. The processing circuitry 520 includes a network interface 522, one or more processing units 524, and nontransitory memory 526. The network interface 522 includes, for example, Ethernet adaptors, Bluetooth adaptors, Wi-Fi adaptors, NFC adaptors, and the like, for converting electronic and/or optical signals received from the network to electronic form for use by the processing circuitry 520. The set of processing units 524 include one or more processing chips and/or assemblies. The memory 526 includes both volatile memory (e.g., RAM) and non-volatile memory, such as one or more ROMs, disk drives, solid state drives, and the like. The set of processing units 524 and the memory 526 together form processing circuitry, which is configured and arranged to carry out various methods and functions as described herein.

In some implementations, one or more of the components of the processing circuitry 520 can be, or can include processors (e.g., processing units 524) configured to process instructions stored in the memory 526. Examples of such instructions as depicted in FIG. 5 include image manager 530, detection manager 540, state manager 550, collision manager 560, and indication manager 570. Further, as illustrated in FIG. 5, the memory 526 is configured to store various data, which is described with respect to the respective managers that use such data.

The image manager 530 is configured to receive a sequence of images from a camera. In some implementations, the camera has a fisheye lens and is situated above the area so that the images in the sequence are 360-degree perspectives of the area. In some implementations, the camera is co-located with the processing circuitry. In some implementations, the image manager 530 receives the sequence of images over a network. In some implementations, the image manager 530 receives the sequence of images over a direct connection to the camera.

The image data 532 includes the sequence of images received by the image manager 530. For example, the image data 532 includes, as the sequence of images, images taken at, e.g., 30 Hz, with each image having, e.g., 1600×1200 pixels. In some implementations, the images are acquired at a higher or lower frequency than 30 Hz, and each image has more than or fewer than 1600×1200 pixels. In some implementations, each image in the sequence is a grayscale image; in some implementations, each image in the sequence has color with a RGB representation.

The detection manager 540 is configured to detect entities in an image such as heads, bodies, beds, and tables. As described above, in some implementations, the detection manager 540 uses a machine learning algorithm to detect a head, a body, a bed, or a table given an image from image data 532. In some implementations, the machine learning algorithm includes a convolutional neural network. As shown in FIG. 5, the detection manager 540 includes a head and body detection manager 541 and a bed and table detection manager 542.

The head and body detection manager 541 is configured to detect a head and a corresponding body or a body and corresponding head in an image from image data 532. In some implementations, the head and body detection manager 541 places a bounding box, e.g., an AABB, around each of the head and body. In some implementations, the head and body detection manager 541 performs a union of the head and body bounding boxes which results in a bounding box for a person. The correspondence of a head with a body to define a person is stored as head/body union data 545 as part of detection data 543 (e.g., head identifier with body identifier). The bounding box defining the source region is stored as region data 544 as part of detection data 543 (e.g., coordinates associated with person identifier).

The head and body detection manager 541 is also configured to generate, as keypoint data 547, keypoints for each of the people in an image. In some implementations, the keypoint data 546 represents keypoints at a head, hands, elbows, and feet of a person. In some implementations, there are fewer or more keypoints in the keypoint data 547. In some implementations, the keypoint data 547 are in the form of spatial coordinates in the area.

The bed and table detection manager 542 is configured to detect a bed and corresponding bedside table in the area in an image from image data 532. In some implementations, the bed and table detection manager 542 places a bounding box, e.g., an AABB, around the union of the bed and table to create, as part of region data 544, the target region. In some implementations, the bed and table detection manager 542 performs a segmentation of the bed and table to create, as segmentation data 546, a segmentation polygon. In some implementations, the segmentation polygon is represented in segmentation data 546 as a set of coordinates. In some implementations, the bed and table detection manager 542 performs the segmentation using a machine learning algorithm.

The state manager 550 is configured to determine, as state data 552, the hygiene state of a source region based on images of the sequence of images of the image data 532. For example, if a person enters the area and performs no hygiene act (e.g., hand washing) in any previous image or over a minimum number of sequential images (e.g., for a minimum time), then the state manager 550 assigns the contaminated state to the source region associated with the person. If, however, there are images in the sequence of the person performing the hygiene act without any other collisions, then the state manager 550 assigns the clean state to the source region associated with the person.

The state data 552 represents an association between a source region and a hygiene state. In some implementations, the state data 552 takes the form of a pair of a source region identifier and a hygiene state.

The collision manager 560 is configured to determine, based on an image in the sequence of images of image data 532, whether a collision between a source region and a target region took place. In some implementations, the collision manager 560 is also configured to determine whether a collision between two source regions took place.

In some implementations, the collision manager 560 detects a collision between a source region and a target region when they are each represented by respective AABBs. In such implementations, the collision manager 560 performs the collision detection by comparing the coordinates in the respective representations in region data 544.

In some implementations, the collision manager 560 detects a collision between a source region and a target region when they are represented by keypoints and a segmentation polygon, respectively. In such implementations, the collision manager 560 may use a machine learning algorithm to determine whether an advanced collision has occurred.

Collision data 562 represents the state of whether a collision between a source region (identified by a source region identifier) and a target region has occurred. In some implementations, the collision data 562 is stored as a pair of a source region identifier and a binary value indicating whether a collision occurred.

Indicator manager 570 is configured to indicate whether a hygiene violation has taken place. For example, if the contaminated state is assigned to a source region and has had a collision with the target region, then the indicator data 572 indicates that a hygiene violation has occurred. If however there is no collision or there is a collision and the clean state is assigned to the source region, then the indicator data 572 indicates that no hygiene violation has occurred.

The components (e.g., modules, processing units 524) of processing circuitry 520 can be configured to operate based on one or more platforms (e.g., one or more similar or different platforms) that can include one or more types of hardware, software, firmware, operating systems, runtime libraries, and/or so forth. In some implementations, the components of the processing circuitry 520 can be configured to operate within a cluster of devices (e.g., a server farm). In such an implementation, the functionality and processing of the components of the processing circuitry 520 can be distributed to several devices of the cluster of devices.

The components of the processing circuitry 520 can be, or can include, any type of hardware and/or software configured to process attributes. In some implementations, one or more portions of the components shown in the components of the processing circuitry 520 in FIG. 5 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 520 can be, or can include, a software module configured for execution by at least one processor (not shown). In some implementations, the functionality of the components can be included in different modules and/or different components than those shown in FIG. 5, including combining functionality illustrated as two components into a single component.

Although not shown, in some implementations, the components of the processing circuitry 520 (or portions thereof) can be configured to operate within, for example, a data center (e.g., a cloud computing environment), a computer system, one or more server/host devices, and/or so forth. In some implementations, the components of the processing circuitry 520 (or portions thereof) can be configured to operate within a network. Thus, the components of the processing circuitry 520 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, image manager 530 (and/or a portion thereof), detection manager 540 (and/or a portion thereof), state manager 550 (and/or a portion thereof), collision manager 560 (and/or a portion thereof), and indication manager 570 (and/or a portion thereof) are examples of such instructions.

In some implementations, the memory 526 can be any type of memory such as a random-access memory, a disk drive memory, flash memory, and/or so forth. In some implementations, the memory 526 can be implemented as more than one memory component (e.g., more than one RAM component or disk drive memory) associated with the components of the processing circuitry 520. In some implementations, the memory 526 can be a database memory. In some implementations, the memory 526 can be, or can include, a non-local memory. For example, the memory 526 can be, or can include, a memory shared by multiple devices (not shown). In some implementations, the memory 526 can be associated with a server device (not shown) within a network and configured to serve the components of the processing circuitry 520.

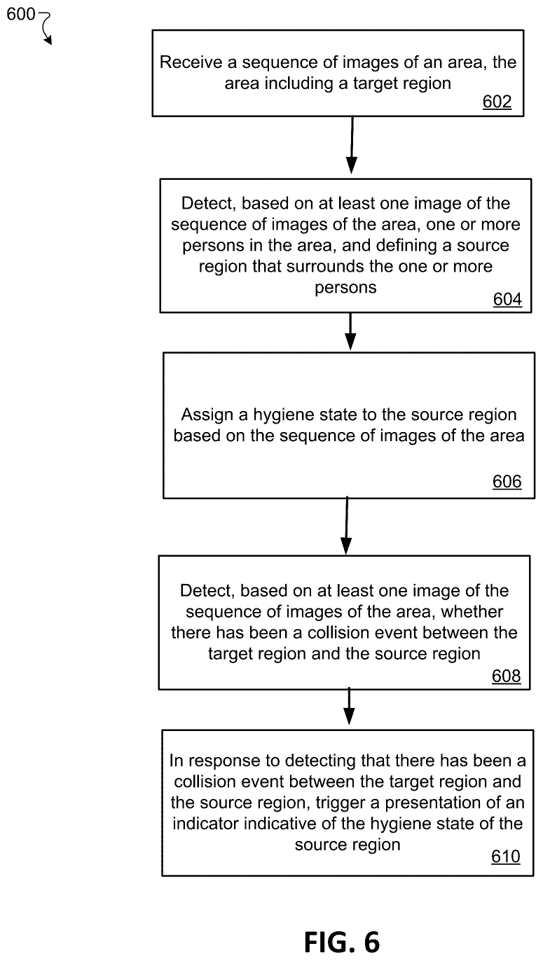

FIG. 6 is a flow chart depicting an example method 600 for automated tracking and detection of hygiene state in a hygiene sensitive area. The method 600 may be performed by software constructs described in connection with FIG. 5, which reside in memory 526 of the processing circuitry 520 and are run by the set of processing units 524.

At 602, the image manager 530 receives a sequence of images of the area, the area including a target region.

At 604, the detection manager 540 detects, based on at least one image of the sequence of images of the area, one or more persons in the area, and defining a source region that surrounds the one or more persons.

At 606, the state manager 550 assigns a hygiene state to the source region based on the sequence of images of the area.

At 608, the collision manager 560 detects, based on at least one image of the sequence of images of the area, whether there has been a collision event between the target region and the source region.

At 610, the indicator manager 570, in response to detecting that there has been a collision event between the target region and the source region, triggers a presentation of an indicator indicative of the hygiene state of the source region.

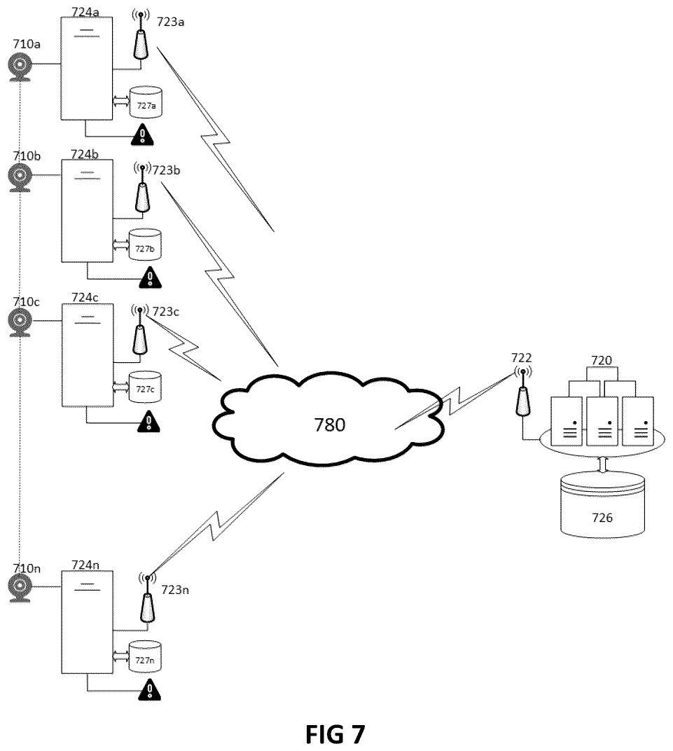

FIG. 7 shows a system with components to implement a hygiene protocol according to the procedures shown in FIGS. 2a, 2b, 2c, and 6. Each cell or room is independent in the sense that processing power, memory, input device, and output devices are present. One or more cameras 710a, 710b, 710c, 710n are input devices. The cameras monitor each room, each cell, and send image data to a processing unit 724a, 724b, 724c, 724n. Each processing unit has an internal and/or external memory. The processing unit has an alarm that constitutes an output device. The alarm can, for example, be a warning light, where the color of the light determines the alarm status. Although a cell is an independent unit, the processing unit can be connected to a wireless network that communicates with a central data center via a cloud 780. The central data center includes communication means, in this example for wireless communication with the cloud 780. Furthermore, the data center includes one or more computers, one or more servers, and one or more storage media such as databases. Collected data from the processors 724a, 724b, 724c, 724n can be processed in the central data center. Processed data can be used in analysis tools. Analysis tools can reveal how many breaches of hygiene rules there are in different departments, cells, or rooms. After some time, one will be able to look at trends to see if the hygiene regime with alarm notification has the desired effect. One can deactivate the monitoring systems in one or more rooms/cells to see if hygiene trends are followed to a lesser extent without alarm notifications.

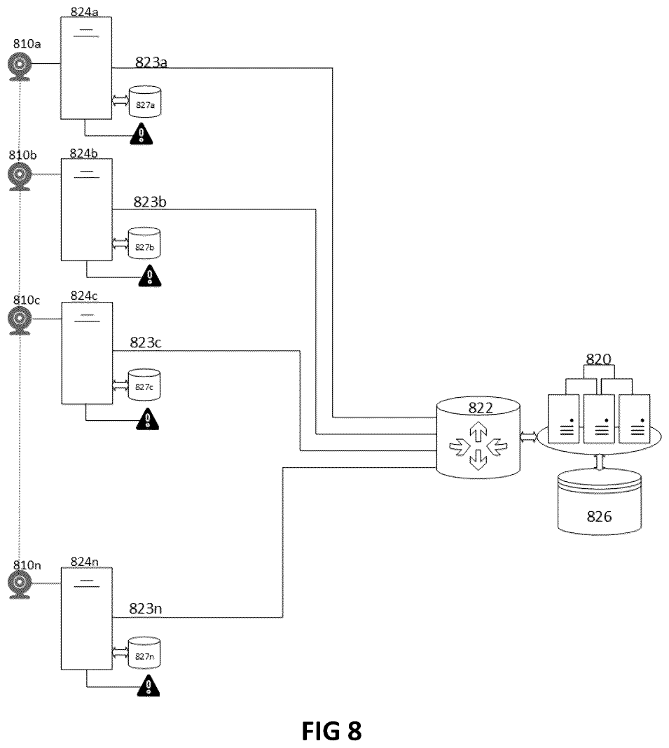

FIG. 8 shows an example of a wired network including the same elements as in FIG. 7, with the same capabilities. A router 822 is connected to the processing units 724a, 724b, 724c, 724n of the complete system.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method for automated tracking and detection of hygiene state in a hygiene sensitive area, comprising:
receiving a sequence of images of the hygiene sensitive area, the hygiene sensitive area including a target region;
detecting, based on at least one image of the sequence of images of the hygiene sensitive area, one or more persons in the hygiene sensitive area, and defining a source region that surrounds each one of the one or more persons;
assigning a hygiene state to the source region based on the sequence of images of the hygiene sensitive area;
detecting, based on at least one image of the sequence of images of the hygiene sensitive area, whether there has been a collision event between the target region and the source region; and
in response to detecting that there has been a collision event between the target region and the source region, triggering a presentation of an indicator indicative of the hygiene state of the source region.

2. The method of claim 1, wherein assigning the hygiene state to the source region includes selecting one hygiene state of a clean state, a contaminated state, or an in process state, and assigning the selected hygiene state to the source region;
wherein in response to the hygiene state assigned to the source region being the contaminated state, the indicator indicates a hygiene violation; and
wherein in response to the hygiene state assigned to the source region being the clean state, the indicator indicates a hygiene non-violation.

3. The method of claim 2, wherein determining the hygiene state of the source region includes:
assigning the contaminated state to the source region upon detecting the one or more persons entering the hygiene sensitive area or the one or more persons leaving the hygiene sensitive area.

4. The method of claim 2, wherein the hygiene sensitive area also includes a hygiene station region; and
wherein assigning the hygiene state to the source region includes:
detecting that there has been a collision event between the source region and the hygiene station region over at least a subset of the sequence of images, the subset of the sequence of images representing a minimum time for which the one or more persons is performing a hygiene act at the hygiene station region; and
in response to detecting that there has been a collision event between the source region and the hygiene station region over at least the subset of the sequence of images, assigning the clean state to the source region.

5. The method of claim 2, wherein assigning the hygiene state to the source region includes:
receiving a signal indicating that the one or more persons has performed a hygiene act at a hygiene station; and
in response to receiving the signal, assigning the clean state to the source region.

6. The method of claim 2, wherein assigning the hygiene state to the source region includes:
detecting a second person in the hygiene sensitive area, the second person being surrounded by a second source region, the second source region having been assigned a hygiene state;
detecting a collision event between the source region and the second source region; and
assigning the hygiene state of the source region based on the hygiene state assigned to the second source region.

7. The method of claim 1, wherein the target region surrounds a patient bed area and includes an axis-aligned bounding box (AABB) around the patient bed area.

8. The method of claim 7, wherein detecting whether there has been a collision event between the target region and the source region includes:
determining whether the source region intersects the AABB.

9. The method of claim 1, wherein the target region surrounds a patient bed area; and
wherein detecting whether there has been a collision event between the target region and the source region includes:
performing a segmentation operation on the patient bed area to produce, as the target region, a polygonal region.

10. The method of claim 9, wherein detecting whether there has been a collision event between the target region and the source region further includes:
determining a set of keypoints on the one or more persons; and
detecting whether at least one of the set of keypoints on the one or more persons has intersected the polygonal region.

11. The method of claim 10, wherein the set of keypoints are located at a head, hands, elbows, and feet of the one or more persons.

12. The method of claim 1, wherein detecting the one or more persons in the hygiene sensitive area includes:
detecting a body of a person, the body being represented by a first rectangular region;
detecting a head of the person, the head being represented by a second rectangular region;
wherein the source region includes an intersection between the first rectangular region and the second rectangular region.

13. The method as in claim 1, wherein detecting whether there has been a collision event between the target region and the source region includes:
using a deep learning algorithm to predict axis-aligned bounding boxes (AABBs) for the one or more persons in the hygiene sensitive area.

14. The method as in claim 13, wherein detecting whether there has been a collision event between the target region and the source region further includes:
determining whether there has been a collision event between two AABBs using either a point vs. AABB method or an AABB vs. AABB method.

15. The method as in claim 13, further comprising:
training the deep learning algorithm by minimizing a loss function of a classification error and a bounding box error.

16. A computer program product comprising a nontransitory storage medium, the computer program product including code that, when executed by processing circuitry, causes the processing circuitry to perform a method for automated tracking and detection of hygiene state in a hygiene sensitive area, the method comprising:
receiving a sequence of images of the hygiene sensitive area, the hygiene sensitive area including a target region;
detecting, based on at least one image of the sequence of images of the hygiene sensitive area, one or more persons in the hygiene sensitive area, and defining a source region that surrounds the one or more persons;
assigning a hygiene state to the source region based on the sequence of images of the hygiene sensitive area;
detecting, based on at least one image of the sequence of images of the hygiene sensitive area, whether there has been a collision event between the target region and the source region; and
in response to detecting that there has been a collision event between the target region and the source region, triggering a presentation of an indicator indicative of the hygiene state of the source region.

17. The computer program product of claim 16, wherein assigning the hygiene state to the source region includes selecting one hygiene state of a clean state, a contaminated state, or an in process state, and assigning the selected hygiene state to the source region;
wherein in response to the hygiene state assigned to the source region being the contaminated state, the indicator indicates a hygiene violation; and
wherein in response to the hygiene state assigned to the source region being the clean state, the indicator indicates a hygiene non-violation.

18. The computer program product of claim 16, wherein the target region surrounds a patient bed region and includes an axis-aligned bounding box (AABB) around a patient bed area.

19. The computer program product of claim 16, wherein the target region surrounds a patient bed area; and
wherein detecting whether there has been a collision event between the target region and the source region includes:
performing a segmentation operation on the patient bed area to produce, as the target region, a polygonal region.

20. An apparatus for automated tracking and detection of hygiene state in a hygiene sensitive area, comprising:
memory; and
processing circuitry coupled to the memory, the processing circuitry being configured to:
receive a sequence of images of the hygiene sensitive area, the hygiene sensitive area including a target region;
detect, based on at least one image of the sequence of images of the hygiene sensitive area, one or more persons in the hygiene sensitive area, and defining a source region that surrounds the one or more persons;
assign a hygiene state to the source region based on the sequence of images of the hygiene sensitive area;
detect, based on at least one image of the sequence of images of the hygiene sensitive area, whether there has been a collision event between the target region and the source region; and
in response to detecting that there has been a collision event between the target region and the source region, trigger a presentation of an indicator indicative of the hygiene state of the source region.

21. The apparatus of claim 20, wherein assigning the hygiene state to the source region includes selecting one hygiene state of a clean state, a contaminated state, or an in process state, and assigning the selected hygiene state to the source region;
wherein in response to the hygiene state assigned to the source region being the contaminated state, the indicator indicates a hygiene violation; and
wherein in response to the hygiene state assigned to the source region being the clean state, the indicator indicates a hygiene non-violation.

22. The apparatus of claim 20, wherein the target region surrounds a patient bed region and includes an axis-aligned bounding box (AABB) around a patient bed area.

23. The apparatus of claim 20, wherein the target region surrounds a patient bed area; and
wherein the processing circuitry configured to detect whether there has been a collision event between the target region and the source region is further configured to:
perform a segmentation operation on the patient bed area to produce, as the target region, a polygonal region.
